(19) United States
(12) Patent Application Publication
(10) Pub. No.: US 2022/0090522 A1
(43) Pub. Date: Mar. 24, 2022

(54) METHOD FOR INTRODUCING HIGHLY PRECOMPRESSED COMBUSTION AIR INTO A COMBUSTION CHAMBER OF AN INTERNAL COMBUSTION ENGINE, HIGH-PRESSURE INLET VALVE THEREFOR AND INTERNAL COMBUSTION ENGINE HAVING SUCH A HIGH-PRESSURE INLET VALVE

(71) Applicant: ERWIN JUNKER GRINDING TECHNOLOGY A.S., Melnik (CZ)

(72) Inventor: Erwin Junker, Bueh/Baden (DE)

(21) Appl. No.: 17/426,180

(22) PCT Filed: Jan. 23, 2020
(86) PCT No.: PCT/EP2020/051598

§ 371 Date: Jul. 28, 2021

(30) Foreign Application Priority Data
Jan. 29, 2019 (DE) 10 2019 201 123.3
Feb. 20, 2019 (DE) 10 2019 202 318.5

(51) Int. Cl. F01L 3/06; F01L 1/053; F02B 17/00; F01L 3/10; F01L 5/02; F01L 5/16

(52) U.S. Cl. CPC F01L 3/06; F01L 1/0532; F02B 17/005; F01L 13/04; F01L 5/02; F01L 5/16; F01L 2810/05; F01L 3/10

(57) ABSTRACT

A method for introducing combustion air into a cylinder (25) of an internal combustion engine, a high-pressure inlet valve (1) provided therefor and an internal combustion engine that operates using the method and the high-pressure inlet valve are described. All the combustion air for the respective cylinders (25) is introduced into the cylinder (25) of the internal combustion engine, by means of a high-pressure inlet valve (1) arranged in the relevant cylinder head (26) and on the basis of a controlled mass flow, such that mixture formation and charge exchange are intensified. In addition, the temperature and/or pressure of the combustion air is measured and the quantity of combustion air is introduced into the cylinder (25), in a controlled manner and on the basis of the measurement results, by means of the high-pressure inlet valve (1) by opening or closing a sliding piston (3) of the high-pressure inlet valve (1) by displacement. As a result of an axial displacement of the sliding piston (3) between guide sections (5) in the housing (2) of the high-pressure inlet valve (1), passage areas (6) for combustion air are blocked in a closed position (7) and opened in an open position (8). In the passage area (6), the sliding piston (3) has two pressurization areas (10, 11) facing each other, the surfaces of which are of equal size or differ from each other when projected in one plane. The first pressurization area (10) can be designed as a poppet valve (12) and the second pressurization area (11) can be designed as an annular surface (13). The internal combustion engine has a high-pressure line (27) for the combustion air, which line is connected to the high-pressure inlet valve (1). With respect to the longitudinal axis of the cylinder (25), the high-pressure inlet valve (1) is arranged in the cylinder head (26) in an upright or horizontal position.

The invention relates to a method for introducing highly pre-compressed combustion air into a combustion chamber of an internal combustion engine, to a high-pressure inlet valve for this, and to an internal combustion engine having such a high-pressure inlet valve.

In the field of engine technology, it is known that a higher charge-air pressure or pressure of the combustion air that is intended for introduction into the cylinder for combustion not only increases the combustion air ratio but also raises the process temperatures in the cylinder at which the combustion takes place. The reason for this lies inter alia in the fact that, with a higher charge-air pressure, the oxygen availability in the cylinder for the combustion can be increased, such that, aside from improved mixture formation, specifically in particular owing to the higher oxygen availability, a better and thus more complete combustion of the fuel that is used can be realized. In this way, the efficiency of the internal combustion engines can be increased.

To achieve this, it has been the case for several decades that the majority of internal combustion engines are supercharged. Numerous supercharging principles have become known, including mechanical superchargers, which have gained significance in particular in the part-load range, and exhaust-gas turbochargers, which utilize the energy of the exhaust gas exiting the cylinder in order, by means of an exhaust-gas turbine operated using the exhaust gases from the cylinder, to drive a compressor which forces the combustion air at elevated pressure into the charge-air line of the engine. With modern exhaust-gas turbochargers, which already also operate in two-stage fashion, charge pressures of approximately 0.3-0.4 MPa are achieved. A considerable increase in efficiency in relation to naturally aspirated engines is already achieved in this way. The further increase of the charge-air pressure through utilization of the exhaust-gas energy is opposed by the fact that ever-improved combustion and ever-improved utilization of the expansion energy leads to lower exhaust-gas temperatures and thus less available energy for an exhaust-gas turbine, for example. In the case of the achievable charge-air pressures, as discussed above, the inlet valves and outlet valves must remain open for a relatively long period of time, such that a valve overlap between inlet valve open and outlet valve open must also be present in order, firstly, on the inlet side, to achieve a follow-up charging effect of the flowing fresh air, in order to also secondly realize—in the sense of a displacing flow—a forcing of the exhaust gases via the outlet valve into the outlet line. In principle, it is however then necessary to realize a relatively rapid closure of the respective valves. For this purpose, it is necessary for relatively powerful springs to be provided, and for the valves, which are generally formed as disk valves, to be moved rapidly into the closed position, that is to say into the valve seat.

In relation to the starting situation discussed, it is the object of the present invention to provide a method for supplying combustion air into the cylinder of an internal combustion engine, a valve suitable for this purpose, and an internal combustion engine having a valve of said type, by means of which higher pressures of the combustion air can be introduced into the combustion chamber than in the case of previously used valves, and which realizes very good dynamic behavior and reproducible closing and opening processes and which, owing to the considerably higher pressures of the admitted combustion air, is nevertheless controllable very effectively in order that the charge exchange and combustion processes in the respective cylinder are better controllable and better influenceable than is possible in the case of engines with conventional inlet systems.

Said object is achieved with a method having the features according to claim 1 and by means of a high-pressure inlet valve according to claim 11 by means of high-pressure inlet valves, slightly modified in relation thereto, having the features according to claim 12 and claim 13. Expedient refinements are defined in the respective dependent claims. Said object is furthermore achieved by means of an internal combustion engine having high-pressure inlet valves of said type, having the features according to claim 29. Expedient refinements are defined in the claims dependent thereon.

According to the invention, the entirety of the combustion air for the respective cylinder is introduced into the cylinder by means of a high-pressure inlet valve arranged in the cylinder head or in the region thereof. The introduction of the entirety of the highly pressurized combustion air into the cylinder is performed here through control at least of the mass flow of the combustion air, specifically such that the combustion air intensifies mixture formation and charge exchange in the cylinder. Here, in the context of the invention, “intensified” is to be understood to mean an improvement of the mixture formation and of the charge exchange in relation to conventional internal combustion engines, in the case of which, as in the case of the charge pressures attainable by means of exhaust-gas turbocharging or mechanical supercharging, the combustion air is introduced, for example, at such an angle into the cylinder that additional swirling of the flow of the combustion air in the cylinder arises, which in turn improves or intensifies mixture formation and charge exchange. The advantage of the method according to the invention now consists in that, for the introduction of the entirety of the combustion air that is required for the combustion in the cylinder of the internal combustion engine, only a single system has to be present, in the case of which the combustion air is introduced into the corresponding cylinder specifically by means of said high-pressure inlet valve, and only by means of one such high-pressure inlet valve. This is thus not a high-pressure inlet valve that implements the additional supply of combustion air into the cylinder, as is already known in the prior art, it rather being the case that the entirety of the combustion air is fed completely by means of the high-pressure inlet valve alone into the cylinder of an internal combustion engine.

According to the invention, aside from the mass flow with the high-pressure inlet valve, the temperature or the pressure of the combustion air is additionally measured and, on the basis of the measurement results, such a quantity of combustion air is introduced into the cylinder of the internal combustion engine that a load-dependent optimized mixture formation and combustion, and thus a high efficiency of the internal combustion engine, are achieved.

According to the invention, the high-pressure valve is formed with a sliding piston, such that, by displacement of the sliding piston, the valve is opened or closed in accordance with the control requirements. In the opened state, the combustion air is introduced through the high-pressure inlet valve into the cylinder, whereas, in the closed state, the supply of combustion air to the cylinder is interrupted, that is to say the combustion air prevails at the high-pressure inlet valve with the high pressure.

The combustion air is preferably supplied to the cylinder while a piston is performing its compression stroke during its movement from bottom dead center to top dead center. The introduction of the combustion air into the cylinder is preferably performed in the region of the first third of the movement of the piston from bottom dead center in the direction of top dead center or after this third, preferably in the region of the middle between bottom and top dead center. It is furthermore preferred that the combustion air is first supplied in the upper third of the movement of the piston from bottom dead center to top dead center or in the immediate vicinity of top dead center, that is to say shortly before the ignition of the fuel in the cylinder.

For an optimization of the operation of the internal combustion engine, it is furthermore preferred that the complete supply of the combustion air to the cylinder is supplied in multiple stages and at different points in time during the movement of the piston from bottom dead center to top dead center. It is self-evident that the more combustion air is introduced into the cylinder for the first time toward top dead center, the lower the compression work of the piston will be, because, owing to the provision of the combustion air at high pressures, the actual compression is not required to the same extent as in a conventional engine. The introduction of the combustion air into the cylinder at different points in time and with a quantity that varies in each case for the individual introduction points is performed preferably in a load-based and/or operation-based manner, also from the aspect of improving exhaust-gas emissions and, for example, the efficiency of the internal combustion engine.

Preferably, the arrangement of the high-pressure inlet valve with its opening directed toward the cylinder is such that the controlled mass flow of the combustion air is admitted into the combustion chamber at such an angle that flow components arise in the interior of the cylinder which intensify the mixture formation and the charge exchange. Here, the introduction of the entirety of the combustion air is also performed from the aspect that both mixture formation and charge exchange in combination and interaction with one another are positively influenced in the sense of an improvement in efficiency.

The single provided system with a high-pressure inlet valve at the cylinder head or in the region of the cylinder head eliminates the need for the conventional complete inlet line system as a main system, via which the combustion air is supplied to the cylinder. The invention is based on the main concept that the systems and methods described in the prior art for the introduction of additional combustion air are made the single system for introducing combustion air, such that, not only is the outlay in terms of apparatus for realizing the method reduced, but control of the quantities of combustion air required for the respective load states can also be realized more easily, because only a single system has to be operated for the introduction of the combustion air.

The pressure prevailing at the high-pressure inlet valve preferably lies in the range from 50 to 150 bar, in particular in the range from 20 to 100 bar and even more preferably in the range from 100 to 120 bar. If the combustion air is introduced at such a high pressure into the cylinder, the corresponding control timing can be reliably realized with the high-pressure inlet valve.

For the method according to the invention, the high-pressure inlet valve is now controlled such that, at the end of the range during which the high-pressure inlet valve is open and admits combustion air at high pressure into the cylinder, the closing process is delayed slightly such that combustion air continues to be additionally introduced into the cylinder in the sense of a follow-up charging action. This follow-up charging effect is in principle conventional in naturally aspirated engines and also in exhaust-gas-turbocharged engines in order to still utilize the kinetic energy of the inflowing combustion air. A delayed introduction into the cylinder in the sense of a follow-up charging effect is to be understood here merely to mean that, although the high-pressure inlet valve remains open for longer, and further air continues to be supplied at relatively high pressure to the cylinder, the cross section for the passage of the air between control edge and compressed-air supply to the cylinder is relatively small, such that this combustion air introduced into the cylinder in the sense of a follow-up charging effect still utilizing the kinetic energy experiences throttling as it passes through the small cross section that is then present. Throttling is to be understood in the theoretical thermodynamic sense as a process with constant enthalpy.

In a further exemplary embodiment, fuel is fed to the combustion air before the latter is fed into the cylinder, and said fuel is introduced together with the combustion air into the cylinder. The adding of the fuel may take place immediately upstream of the high-pressure inlet valve or in the high-pressure inlet valve, at any rate before the combustion air is introduced into the cylinder. Here, it is possible that the fuel added to the combustion air is supplied as additional fuel aside from the normal introduction to the cylinder by means of, for example, an injection nozzle.

The fuel is preferably combustion gas and/or liquid fuel, that is to say gaseous or liquid or a mixture of both.

Preferably, the combustion air is supplied from a pressure vessel to the high-pressure inlet valve and thus via the high-pressure inlet valve to the cylinder. This pressure vessel with the combustion air replaces all otherwise conventional supercharging systems of the internal combustion engine.

According to the invention, the high-pressure inlet valve is formed such that highly pre-compressed combustion air can be introduced into a combustion chamber of an internal combustion engine, that is to say the high-pressure inlet valve is attached to an internal combustion engine of said type and supplies, to the combustion chamber thereof, the quantity of combustion air and thus oxygen that is required for an effective combustion and high efficiency of the internal combustion engine. The high-pressure inlet valve has a sliding piston with cylindrical piston sections, which sliding piston is guided in a housing. The fit dimensions between housing and piston are selected to be relatively narrow, such that reliable sealing can be achieved. The axial length of the cylindrical piston sections is adapted to axially extending guide sections, which are of congruent shape with respect to the external shape of the cylindrical piston sections, in the housing such that, during an axial displacement of the sliding piston, passage regions of the combustion air which are arranged between the guide sections in the housing are shut off in a closed position, and in this closed position no combustion air is admitted or can pass into the combustion chamber. Here, the passage region within the housing is arranged, and delimited or enclosed by the guide sections, such that the axial longitudinal extent of the cylindrical piston section, or the cylindrical piston section, can reliably seal off the passage region in the closed position.

In the case of corresponding further axial displacement of the sliding piston into a passage position, combustion air is admitted through a combustion air inlet through the passage region or the passage regions into the combustion chamber. It is thus ensured that the combustion air is reliably admitted, with the corresponding pressure in the passage region, into the combustion chamber. The sliding piston, in the passage region, has two regions which face toward one another and which are formed as first and second pressure-application region, whose areas, projected onto a plane, are of equal size. The two pressure-application regions thus enclose between them the passage region for the combustion air, such that then the full cross section of the passage region is opened up.

It is essential to the invention that the first and the second pressure-application region are of equal size with regard to areas projected onto a plane perpendicular to the longitudinal extent of the movement of the sliding piston in the housing. The advantage of this area equality consists in that, despite the high pressure at which the pre-compressed combustion air is to be introduced into the combustion chamber of the internal combustion engine, a displacement of the sliding piston and thus control of the supply of combustion air to the combustion chamber of the internal combustion engine can be performed easily, because the sliding piston does not have to work against the working pressure at which the pre-compressed combustion air is supplied to the high-pressure inlet valve and thus to the combustion chamber of the internal combustion engine, but rather only has to overcome the friction force and/or the spring force which a drive cam, for example, must work against.

It is the intention, with the high-pressure inlet valve according to the invention with which an internal combustion engine is equipped, for the charge pressures of 0.3 to 0.4 MPa achievable in the case of conventional supercharging systems to be replaced by pre-compressed combustion air with pressures in the range from 50 to 150, in particular 20 to 100 and furthermore in particular 100 to 120, and in exceptional cases even up to 200 bar. The edge control with which the high-pressure inlet valve operates, and the exact guidance of the cylindrical piston sections in the housing with congruent shaping, reliably allow not only good sealing in the valve with respect to the high pressures at which the combustion air prevails at the valve and can be introduced into the cylinder or combustion chamber of the internal combustion engine, but also very exact control of the inlet cross sections and thus of the quantity of combustion air introduced into a combustion chamber.

Altogether, for reliable control of the quantity of fresh combustion air that is to be introduced into the combustion chamber of the internal combustion engine, very precisely functioning dynamics of such a high-pressure inlet valve are necessary. If, for example, with regard to the pressure level that is envisaged by the invention, one assumes a pressure of 50 bar on the disk valve, which has for example a diameter of 32 mm, this would result in a unilateral pressure force of for example 3.5 kN on the disk valve of the internal combustion engine. This combustion air supply present at the inlet valve has the effect that less energy would have to be consumed during the opening of the high-pressure inlet valve. During the closing of the valve, this force component that is imparted by the pressure spring would thus counteract, such that, even in the case of an equal closing force imparted by said pressure spring, the force would be approximately 3.5 kN too low. This would have the effect that the spring force would have to be correspondingly increased. If the spring force is not correspondingly increased, this would have the result that the closing times would be considerably lengthened or that the valves would no longer be able to be reliably closed within the required short period of time. This is the case because the disk valve also has a projected area of equal size to the area of the second pressure-application region.

At the rotational speeds of modern internal combustion engines, the charge exchange times are

extremely short as regards the absolute time duration, which however requires the valve opening phase to take place extremely rapidly. If, as indicated above, the spring force is increased, this in turn means that the resulting forces on the system as a whole become much higher. This in turn would have the effect that the entire valve drive would have to be of much more stable and considerably more material-intensive design. This would have the result that this solid design in order to be able to adhere to the parameters discussed above does not necessarily allow for the required rapid and reliable dynamics of the system, not to mention increased costs. It is to be noted that, for example in the case of a four-stroke engine that runs at a rotational speed of for example 4000 revolutions per minute, such a valve must be opened and closed approximately 2000 times per minute.

Since, according to the invention, a pressure-balanced high-pressure inlet valve is provided, there is, for the supply of the combustion air, no longer a dependency on the supply pressure as regards the control of the inlet valve. Corresponding pressure compensation is achieved through configuration of the pressure-application regions such that the size thereof, that is to say of the first and of the second pressure-application region, are approximately equal. Slight deviations from pressure-application regions of equal size are however possible. A deviation from pressure-application regions of equal size may be necessary in order to be able to even better adapt certain dynamic control operations of the internal combustion engine to the practical conditions. Since the combustion air is introduced at a high pressure into the combustion chamber, the supply of the air can be introduced at any point in time during, for example, the piston movement from bottom dead center to top dead center. The major advantage of the high-pressure inlet valve according to the invention consists in that, owing to the compensation of the pressure-application regions with respect to one another, no resultant axial forces act on the valve drive.

According to a second aspect of the invention, a high-pressure inlet valve in the manner of that described above according to the first aspect is provided, in the case of which the sizes for the first and the second pressure-application region deviate from one another within certain limits as regards the projected area of the pressure-application region. This is conceivable and expedient in particular if, for example, it is sought for a force component to be effected in a targeted manner in a specifically intended direction for the purposes of further optimization with regard to the resultant forces on the valve drive. In particular, the certain inequality set by means of the somewhat unequal areas, or a certain degree of non-compensation of the axial forces, can contribute to an improvement in the dynamics of the valve system as a whole, in particular from the aspect of the rapid switching of the valve in order to allow for the rapid charge exchange at in particular also relatively high rotational speeds of the internal combustion engine.

The basic construction and the advantages and demands on a high-pressure inlet valve according to this second aspect correspond to those of the first aspect, such that these will not be repeated.

According to a third aspect, a high-pressure inlet valve according to the invention for introducing highly compressed or highly pre-compressed combustion air in a combustion chamber of an internal combustion engine is provided, which high-pressure inlet valve is part of the internal combustion engine and has a sliding piston which is guided in a housing. The sliding piston has a cylindrical piston section, the axial length of which is adapted to an axially extending guide section, which is formed so as to be of congruent shape with respect to said cylindrical piston section, in the housing such that, during its axial displacement in the housing, the piston section guided in the guide section shuts off a passage region, arranged in the housing, for combustion air in the closed position of said piston section. In the event of corresponding axial displacement of the sliding piston and thus of the piston section, which on the one hand, in its closed position, shuts off the combustion air, in the event of a displacement of the sliding piston into its passage position, said sliding piston allows the passage of combustion air into the combustion chamber. The sliding piston has, in the passage region, two regions which face toward one another and which are formed as first and second pressure-application regions, the areas of which, projected onto a plane and lying perpendicular to the longitudinal axis of the sliding piston, are of equal size or differ from one another slightly. Here, the first pressure-application region is formed in the manner of a disk valve and the second pressure-application region is formed as an annular surface. The pressure-application region formed as a disk valve is assigned to the cylinder. In the event of corresponding spring loading of the sliding piston and preferably actuation by means of a cam of a camshaft, the high-pressure inlet valve according to the invention can be controlled in accordance with the demands of the charge exchange and the high degree of charging of the cylinder with combustion air and thus with oxygen for improved combustion.

If the projected area of the first pressure-application region, that is to say that which is on the disk valve, is of approximately the same size as the second pressure-application region area arranged opposite the first pressure-application region and formed as an annular surface, it is also the case here that there are no resulting force components in an axial direction. The expenditure of force for the control of the valve is thus directed merely to friction and overcoming the spring force for the purposes of opening said valve. The closing process of said valve is then performed by means of a correspondingly dimensioned spring. Depending on the closing speed and prevailing pressure conditions between the pressure at which the combustion air is supplied to the combustion chamber and the pressure prevailing in the cylinder after the combustion, the closing process of the high-pressure inlet valve is correspondingly controlled with regard to the closing speed in order to achieve usable short control times, by means of which the valve opening diagram can be optimized. In the context of rapid filling of the combustion chamber, the opening curve must be as steep as possible with regard to the admitted combustion air quantity.

In order to omit corresponding masses, instead of conventionally used steel valves, the use of ceramic materials may also be advantageous. In the case of relatively lightweight materials which however likewise ensure strength, the dynamics of the valve drive in particular for the opening and closing process can be positively influenced in the sense of an optimization of movement allowing for optimized dynamics. The valve housing and also the sliding piston may be composed not only of steel but also of cast metal, of high-strength aluminum alloys or aluminum-magnesium alloys, or other materials or alloys.

A considerable advantage of the high-pressure inlet valve according to the invention or of the internal combustion engine having a high-pressure inlet valve according to the invention of said type consists in that, owing to the high pressures, the volumes of the charge-air system are made smaller, such that greater compactness of the internal combustion engine according to the invention can be achieved.

According to one refinement of the invention for the first two aspects of the high-pressure inlet valve according to the invention, the first pressure-application region is formed, with its contour at the combustion air outlet from the valve, that is to say at the inlet of the combustion air into the combustion chamber, in the manner of a disk valve. Here, in this inflow region, an additional cylindrical guide in the manner of a guide section may be provided, which, by means of a spoke-like reinforcement, achieves not only an increased stability of this part, which is at the front in a direction of introduction of the combustion air into the combustion chamber, of the high-pressure inlet valve according to the invention, but also realizes a better guidance of the sliding piston in the housing of the high-pressure inlet valve. Preferably, the second pressure-application region, which is situated opposite the first pressure-application region, is formed as an annular surface, preferably as a planar annular surface. The annular surface may also deviate from a planar form owing to the uniform pressure propagation on all sides; for the pressure forces that act on said pressure-application region, it is at any rate the projected area that is relevant. The projected area is projected onto an imaginary plane which is arranged perpendicular to the longitudinal axis of the inlet valve according to the invention.

The guide webs, which extend in the region of the first pressure-application region radially between a shank and the guide section, are preferably formed such that they simultaneously impose on the air flowing into the combustion chamber a directional component in the sense of a swirling flow in the cylinder, such that, in this way, improved mixture formation and thus combustion in the cylinder are additionally achieved.

It is however preferably also possible that guide-vane-like webs are situated, proceeding from the shank, in the region of the valve disk of the first pressure-application region, which webs are not necessarily connected to an outer ring in the manner of a guide section but are provided, similarly to guide vanes of turbines, to impart a defined direction to a medium flowing along said guide vanes, and possibly also an acceleration in the case of varying spacings between the vanes. The mixture formation and ultimately also the combustion in the combustion chamber of an engine can thus be influenced.

Preferably, according to a further exemplary embodiment of the high-pressure inlet valves according to the first and the second aspect, the first and the second pressure-application region are assigned to their respective axially extending cylindrical piston section. The two cylindrical piston sections are guided in a respective guide section in the housing and, by way of their pressure-application regions facing toward one another, delimit the passage region between them. In the event of an axial movement of the sliding piston, the cylindrical section that extends from the first pressure-application region opens up air inlet channels or air passage channels, which are arranged in the housing and via which the pre-compressed combustion air supplied to the high-pressure inlet valve according to the invention is supplied into the combustion chamber of an internal combustion engine, or shuts off said air inlet channels or air passage channels.

By means of the number of air inlet channels, which are preferably arranged adjacent to one another in a circumferential direction with a defined spacing to one another or with a spacing to one another which generates defined flow conditions in the combustion chamber, the admitted combustion air quantity can be influenced. Preferably, the air inlet channels or air outlet channels are inclined with respect to the axial longitudinal axis of the high-pressure inlet valve in the manner of a converging direction, that is to say a direction toward the axis, or in the manner of a diverging direction, pointing away from the longitudinal axis of the sliding piston. A concentric arrangement with respect to the longitudinal axis of the sliding piston, with regard to the respective longitudinal axis of the air inlet channels, may however also preferably be provided.

Preferably, a further exemplary embodiment of the high-pressure inlet valve with regard to the first and the second aspect is formed such that the passage region for the combustion air in the housing, which passage region is delimited by the first and the second pressure-application region in the case of corresponding positioning of the sliding piston in the housing, is of stepped form, wherein the high-pressure inlet valve has, in the housing, a combustion air inlet and a combustion air outlet. The combustion air inlet supplies the pre-compressed combustion air to the high-pressure inlet valve from a supply source, whereas the combustion air outlet constitutes, as it were, the combustion air inlet into the combustion chamber of the internal combustion engine. The two regions are preferably arranged offset with respect to one another in an axial direction with respect to the sliding piston. It is thus possible, or achieved, that the combustion air inlet is, depending on the position of the sliding piston, shut off or opened for the combustion air by means of a first cylindrical piston section which extends from the first pressure-application region and which is guided in the housing in the guide section. The axial length of the first cylindrical piston section must in this case be greater than the axial extent of the passage region for the combustion air, such that the encircling edge, which is at the front in the direction of the combustion chamber and at the rear in the direction of the passage region, of the cylindrical piston section ensures a reliable seal with respect to the combustion air that is conducted to the combustion air inlet. By means of a very precisely manufactured cylindrical shape of the piston section and of the cylindrical bore shape of the associated congruently shaped guide section, a clean fit is ensured which ensures the corresponding sealing function even at the intended high pressures of up to 150 MPa.

Preferably, during corresponding displacement of the sliding piston, the cylindrical piston sections assigned to the respective pressure-application regions protrude into corresponding chambers of the housing. Said chambers preferably have ventilation bores via which, as the cylindrical piston sections protrude into the respective chamber, allow the air that is pressurized there to escape. During corresponding movement of the cylindrical piston sections out of of the chamber again proceeding from the protruding-in state, air is drawn in via the ventilation bores, such that the negative pressure has only low values. These ventilation bores have such a diameter that at most a low level of throttling occurs.

Depending on the conditions and depending on the influencing of the flow of the combustion air that enters the cylinder or the combustion chamber of the internal combustion engine, the combustion air inlet and/or the combustion air outlet are provided with a circular, elongate or elliptical cross section. Here, the cross-sectional shape is dependent on the desired flow in the combustion chamber for the purposes of intensifying the mixture formation and the subsequent combustion.

Preferably, the cylindrical piston sections are formed in the manner of lubricant-receiving piston annular grooves. These piston annular grooves are formed so as to be capable of receiving lubricant such that the sliding surfaces that are formed between the cylindrical piston sections and the guide sections are provided with corresponding lubrication, such that wear is counteracted and in particular also the friction force during the axial displacement of the sliding piston in the housing is greatly reduced.

Preferably, the high-pressure inlet valve according to the second or third aspect does not have identically sized areas of the first and of the second pressure-application regions, it rather being possible for said areas to differ from one another by up to at most 20%. It is thus sought to directly influence the force conditions during the control of the high-pressure inlet valve and the dynamics in particular at high rotational speeds, and thus when rapid opening and closing of the high-pressure inlet valve according to the invention are required.

It is furthermore preferred that the high-pressure inlet valve is formed with a sliding piston which, at least at the end of its closing movement, imparts a radial movement component to the disk valves, such that different surfaces in the seat of the disk valve in the housing come into contact during every closing process. This is firstly owing to high, long-lasting leak-tightness that is ensured during engine operation, inter alia because deposits, possibly resulting from unburned fuel, in the valve seat region are eliminated again upon every closing process. Cleaning of the valve seat, and thus high leak-tightness of the disk valve at its seat in the housing, are thus ensured.

According to a further aspect, the internal combustion engine according to the invention is equipped with a high-pressure inlet valve, arranged in a cylinder head, for the admission of combustion air at high pressure into a combustion chamber, wherein the high-pressure inlet valve is a valve designed in accordance with the features according to any one of claims 1 to 15. This high-pressure inlet valve is arranged in a manner of an inlet valve between a high-pressure line, which supplies the combustion air at high pressure to the high-pressure inlet valve, and the combustion chamber. By means of this high-pressure inlet valve, the highly pressurized combustion air is admitted from precisely one high-pressure line via a passage region in the high-pressure inlet valve into the combustion chamber.

The high-pressure inlet valve is, with regard to a first aspect of the internal combustion engine, arranged in the cylinder head in standing fashion in relation to the longitudinal axis of the cylinder or of the combustion chamber. The bottom side of the high-pressure inlet valve thus points directly toward the combustion chamber. This has the advantage that conventional cylinder heads that are equipped with a conventional inlet valve can possibly be used, because the corresponding guides and receptacles provided for the seat and guidance in the cylinder head can at any rate be used for the required space for the high-pressure inlet valve according to the invention. The advantage of the high-pressure inlet valve according to the invention consists, inter alia in conjunction with the use in an internal combustion engine, in the fact that large-volume inlet lines are not required, such that the space requirement for the supply of the combustion air to the combustion chamber of the internal combustion engine is reduced, and thus the compactness of an engine of said type can be increased.

According to a second aspect of the internal combustion engine, with regard to the basic construction which corresponds to that according to the first aspect for the internal combustion engine, the high-pressure inlet valve is arranged in the cylinder head in lying fashion in relation to the longitudinal axis of the cylinder or of the combustion chamber. The lying arrangement of the high-pressure inlet valve has the advantage that the supply of the highly pressurized combustion air can take place from the top side of the cylinder head, and the passage region for the combustion air through the high-pressure inlet valve into the combustion chamber of the internal combustion engine can be implemented substantially transversely or perpendicularly with respect to the longitudinal axis of the sliding piston of the high-pressure inlet valve.

The sliding piston of the high-pressure inlet valve is preferably loaded by means of a spring, and a cam, which acts counter to the spring force, of a camshaft is provided for the displacement of said sliding piston from a position in which it shuts off a passage of combustion air into the combustion chamber into a position in which it allows the passage of combustion air into the combustion chamber, such that, analogously to the control of conventional inlet and outlet valves, an opening can be affected by means of the cam as the camshaft rotates. Here, the spring, which the respective cam must work against, ensures that, after the opening of the high-pressure inlet valve and after the required combustion air quantity has been admitted, the sliding piston is transferred back into its closed position as rapidly as possible.

Preferably, the high-pressure inlet valve operates with a pressure in the range from 2 to 20 MPa and is controllable such that the combustion air can be admitted into the cylinder such that no separate stroke is required for a charge exchange in a four-stroke engine, and nevertheless, by means of the pressure at which the combustion air is admitted into the combustion chamber via the high-pressure inlet valve, mixture formation occurs in the cylinder more intensely with regard to the injected fuel quantity than is the case in internal combustion engines with, for example, conventional supercharging in a relatively low-pressure range of currently 0.3 to 0.4 MPa. By means of the high pressure at which the combustion air is supplied to the combustion chamber, the time of the opening of the high-pressure inlet valve can be controlled in an effective manner such that an optimum supply of combustion air is ensured, with regard also to the combustion that takes place after the supply of the combustion air and after the mixture formation.

Further advantages, possible uses and details regarding the high-pressure inlet valve according to the invention and the internal combustion engine equipped with such a valve will now be discussed in more detail with reference to the appended drawings.

In the drawings:

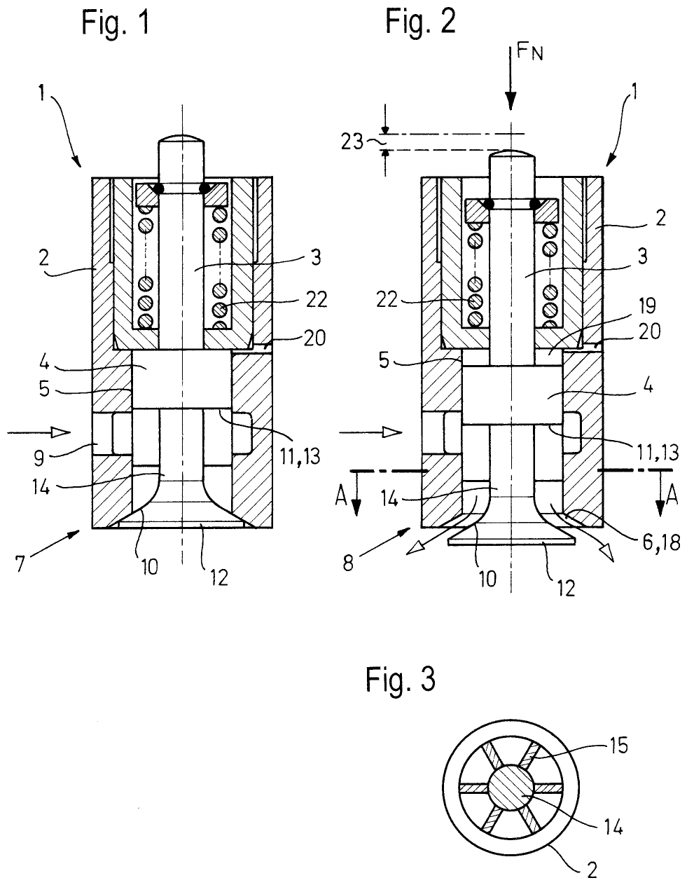

FIG. 1 shows a first exemplary embodiment of a high-pressure inlet valve according to the invention in a closed position with disk valve;

FIG. 2 shows a high-pressure inlet valve as per FIG. 1 in a passage position;

FIG. 3 shows a sectional view through housing and shank of the sliding piston as per FIG. 2;

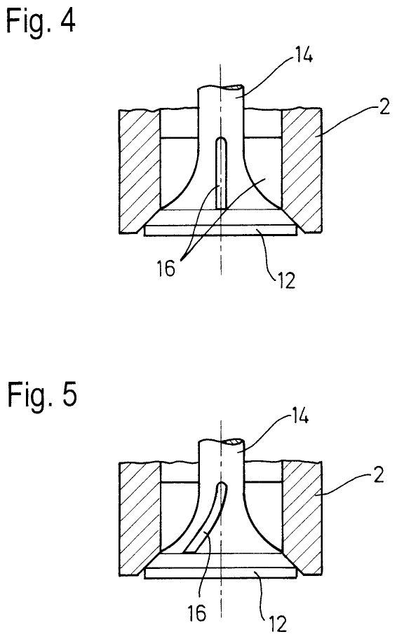

FIG. 4 shows the combustion air outlet, closed by means of a disk valve, of the high-pressure inlet valve with guide-vane-like webs on the head of the disk valve in an axial orientation;

FIG. 5 is an illustration as per FIG. 4, but with curved guide-vane-like webs in the region of the combustion air outlet of the high-pressure inlet valve in a closed position;

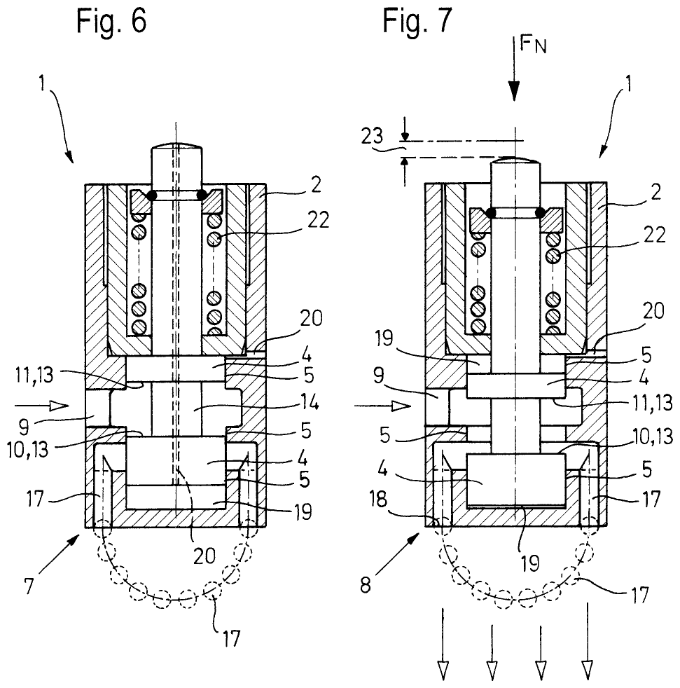

FIG. 6 shows a further exemplary embodiment of the high-pressure inlet valve according to the invention with a sliding piston with two cylindrical sections which are guided in guide sections in the interior of the valve housing, wherein a multiplicity of air inlet channels for the introduction of the combustion air into the combustion chamber is provided in the manner of a ring;

FIG. 7 shows the high-pressure inlet valve as per FIG. 6, but in a passage position for the supply of combustion air through the high-pressure inlet valve into a combustion chamber of an internal combustion engine;

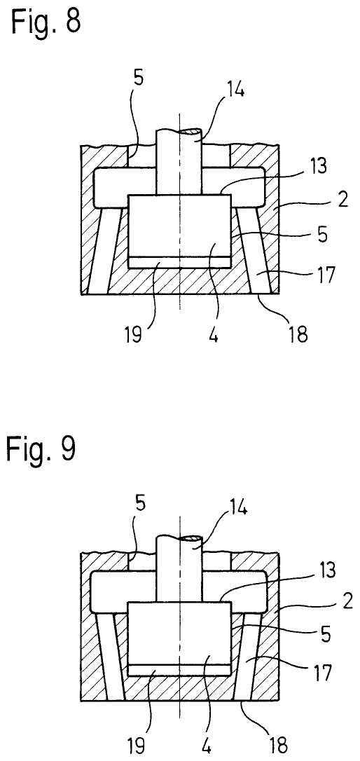

FIG. 8 shows an exemplary embodiment as per FIGS. 6 and 7, but with air inlet channels which have a direction which diverges in relation to the longitudinal axis of the sliding piston;

FIG. 9 shows an exemplary embodiment as per FIG. 8, but with air inlet channels which have a direction which converges in relation to the longitudinal axis of the sliding piston;

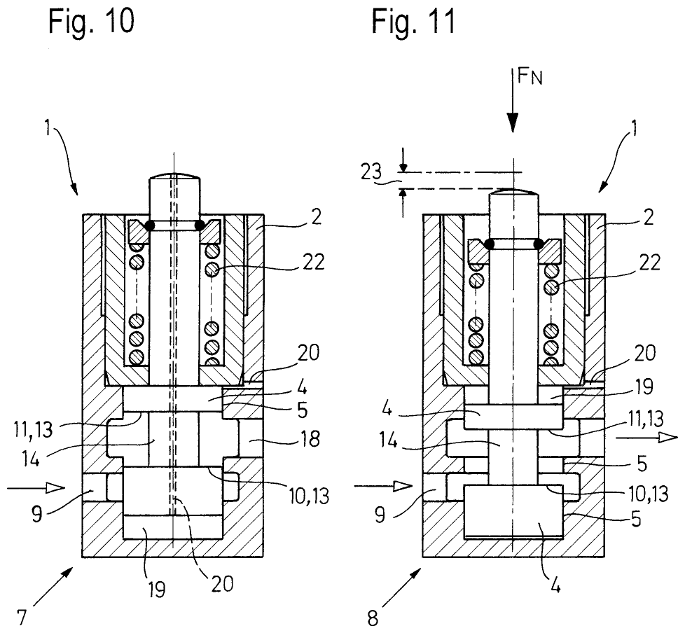

FIG. 10 shows a further exemplary embodiment of a high-pressure inlet valve in a closed position according to the invention, with combustion air inlet and combustion air outlet in planes arranged offset with respect to one another;

FIG. 11 shows the exemplary embodiment of the high-pressure inlet valve according to the invention as per FIG. 10, but in a passage position;

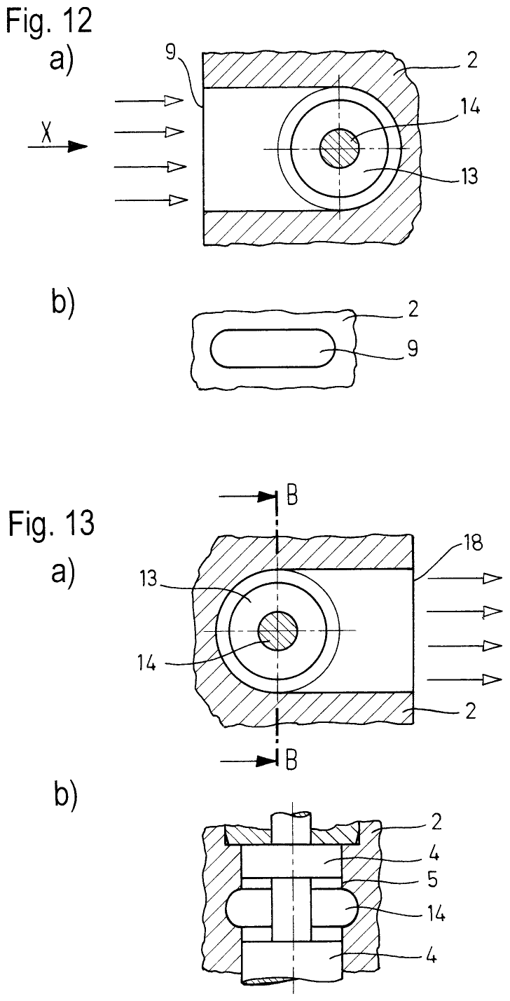

FIG. 12a) shows a detail section of the region of the combustion air inlet of the high-pressure inlet valve as per FIGS. 10 and 11;

FIG. 12b) shows a side view, from the left, of the detail as per FIG. 12a) in the form of a channel which is formed as an elongated hole in cross section;

FIG. 13a) shows the region of the combustion outlet as a detail section of the high-pressure inlet valve according to the invention as per FIGS. 10 and 11;

FIG. 13b) shows a sectional view along the section plane B-B as per FIG. 13a), in which the passage region in the interior of the valve is formed as an annular chamber arranged around the shank of the sliding piston;

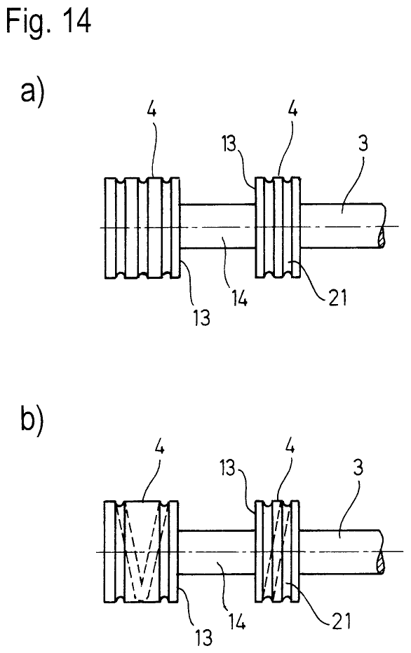

FIG. 14a) shows a sliding piston in accordance with a high-pressure inlet valve according to the invention as per FIGS. 10 and 11, with piston annular grooves on the cylindrical piston sections for lubrication purposes;

FIG. 14b) shows a sliding piston in accordance with a high-pressure inlet valve according to the invention as per FIGS. 10 and 11, with piston annular grooves running along a helical line on the cylindrical piston sections for lubrication purposes;

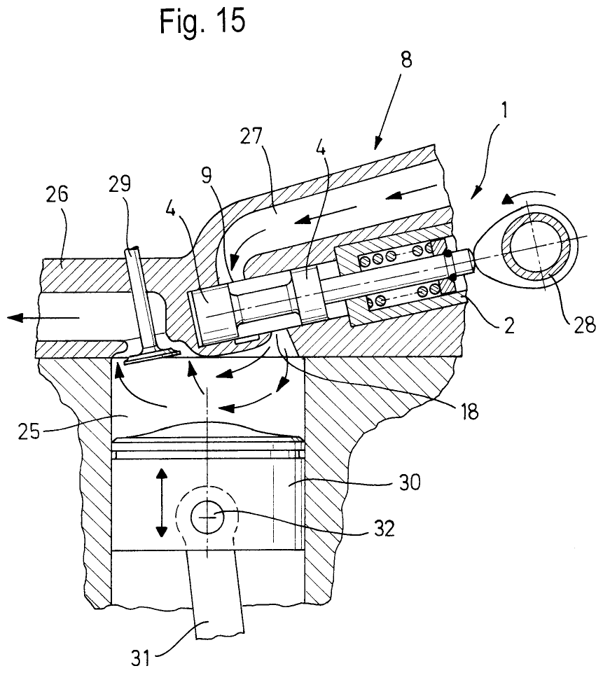

FIG. 15 shows a detail sectional view of the arrangement of the high-pressure inlet valve according to the invention in the cylinder head of an internal combustion engine in a passage position;

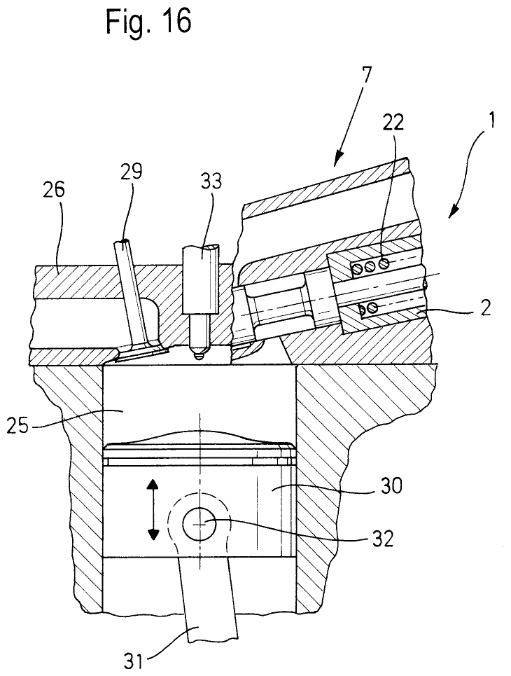

FIG. 16 shows a detail sectional view of a cylinder and of a cylinder head with installed high-pressure inlet valve according to the invention in a closed position;

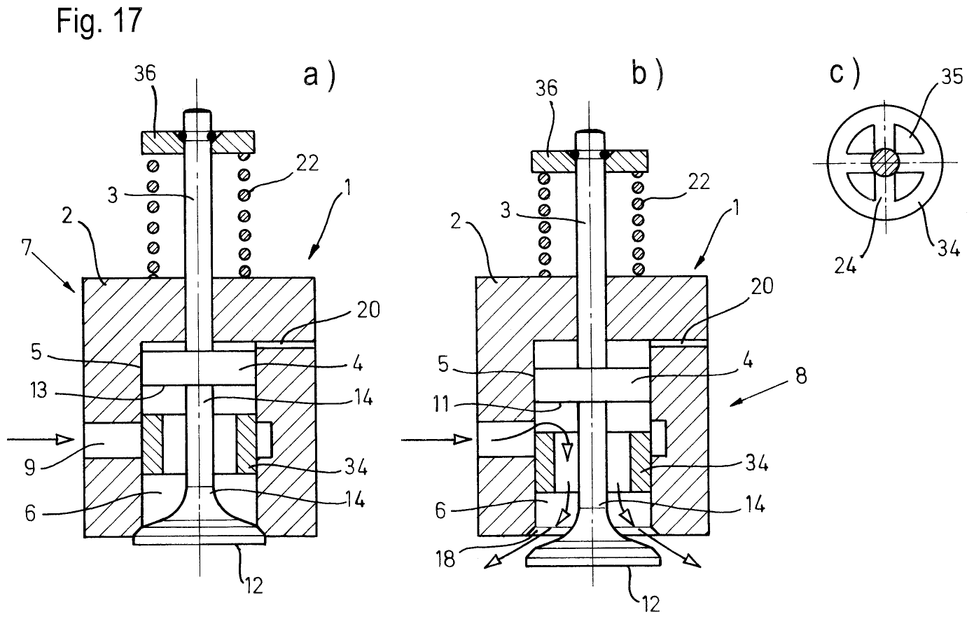

FIG. 17a) shows a high-pressure inlet valve according to the invention with a disk valve as first pressure-application region and with a cylindrical piston section with annular surface as second pressure-application region and with an additional piston for the opening and closing of the valve;

FIG. 17b) shows the high-pressure inlet valve as per FIG. 17a), but in an open position for the admission of combustion air into the cylinder through the interior of the additional piston and the disk valve seat region;

FIG. 17c) shows a sectional view through the shank of the sliding piston of the high-pressure inlet valve according to the invention, with a view of the additional piston from below;

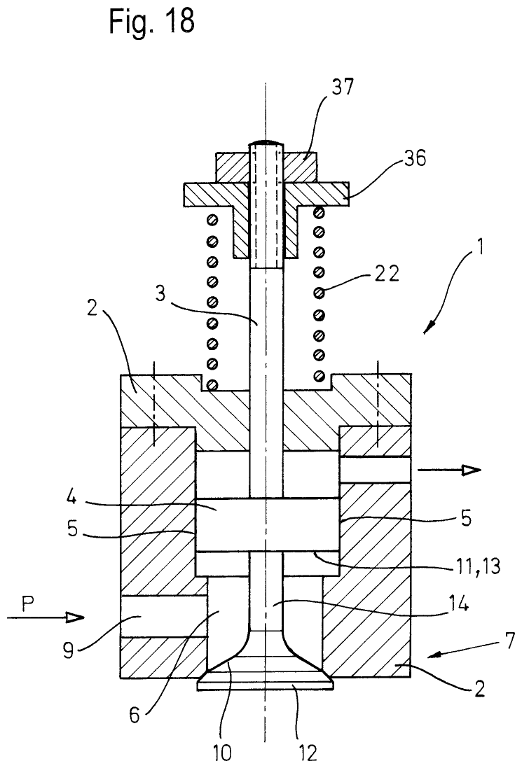

FIG. 18 shows a high-pressure inlet valve according to a second exemplary embodiment, in which the second pressure-application region, in the form of a cylindrical piston section, is of larger dimensions, with regard to the effective annular surface, than the effective annular surface of the first pressure-application region in the form of a disk valve;

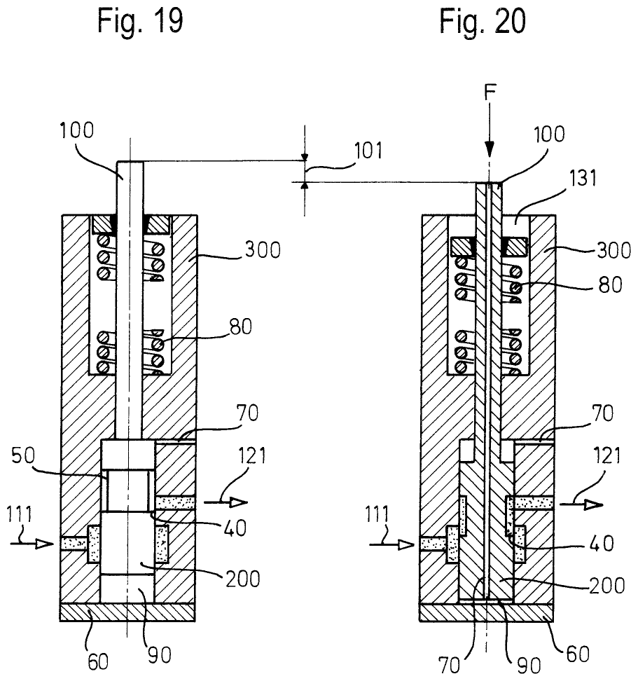

FIG. 19 shows a high-pressure inlet valve for the method according to the invention in a sectional illustration in a closed state; and

FIG. 20 shows the high-pressure inlet valve as per FIG. 1) in an opened state.

FIG. 1 illustrates a high-pressure inlet valve 1 according to the invention in cross section. The valve has a housing 2, within which a sliding piston 3 is guided. For this purpose, the sliding piston 3 has a region which is formed as a cylindrical piston section 4 and which is guided in sliding fashion in the housing 2 on a guide section 5 which is formed so as to be of congruent shape with respect to the cylindrical piston section 4. The cylindrical piston section 4 of the sliding piston 3 is larger, in terms of its diameter, then a shank 14 which extends downward from the cylindrical piston section 4 in the direction of an inlet opening in the form of a combustion air inlet 9 in the direction of a combustion chamber 25 (not illustrated). On the opposite side of the cylindrical piston section 4 in relation to this, there is provided an elongation of the shank 14 of the sliding piston 3, with an insert in which there is arranged a spring 22 which serves for the opening of the high-pressure inlet valve 1 in order that highly pre-compressed combustion air can be admitted into the combustion chamber 25 of an internal combustion engine. A pressure force F_{N} (see the vertically downwardly pointing arrow at the top in FIG. 2) pushes the sliding piston 3 downward by an opening stroke 23 of the high-pressure inlet valve 1, such that the combustion air outlet 18 is fully open, that is to say the high-pressure inlet valve 1 is situated in the passage position 8.

FIG. 1 illustrates the closed position 7 of the high-pressure inlet valve 1. In the combustion air outlet 18 (see FIG. 2), a closing disk 12 in the form of a disk valve closes in a seat formed in the housing 2 and thus prevents a passage of combustion air, the combustion air inlet 9 of which is provided at the left-hand side by an inlet opening. The combustion air itself is indicated by the arrow pointing horizontally to the right. In the closed position 7 of the high-pressure inlet valve 1, the sliding piston 3 protrudes with its upper annular surface, oriented in the direction of the spring insert, into a chamber 19 which is connected to the outside via a ventilation bore 20. As the sliding piston 3 protrudes in by way of its upper annular surface of the cylindrical piston section 4, the air is forced out of the chamber 19 provided there (see FIG. 2) via the ventilation bore 20.

An essential criterion for the functioning of the high-pressure inlet valve 1 according to the invention consists in that the annular surface 13, which faces toward the passage channel, forms a second pressure-application region 11, and the disk valve 12, which faces toward the passage region 6 for the combustion air, forms a first pressure-application region 10. The first pressure-application region 10 forms a projected area configured perpendicularly with respect to the longitudinal axis of the sliding piston 3 and has a size equal to the projected area of the annular surface 13 on the cylindrical section 4 of the sliding piston 3, that is to say is equal to the second pressure-application region 11. Owing to this equality of area of the projected areas, there are no resultant axial forces, specifically irrespective of the magnitude of the pressure of the combustion air that is intended for admission into the combustion chamber of an internal combustion engine. The sliding piston 3 itself is forced by means of a cam of a camshaft, or some other drive device, from the closed position 7 into the passage position 8 counter to the spring force F_{N} and, when the cam is withdrawn, said sliding piston is moved by the action of the spring force, correspondingly to the intensity of the spring force, rapidly back into the closed position 7, in which the closing disk 12 of the disk valve abuts against the seat and imparts a sealing action there.

FIG. 2 illustrates the high-pressure inlet valve 1 in the case of which the sliding piston 3 is however situated in the passage position 8, which is indicated by the arrow at the combustion air outlet 18. When the combustion air outlet 18 is open, the passage region 6 is opened up for the combustion air, such that the combustion air flows at high pressure and thus also high flow speed between the seat and valve disk and passes into the combustion chamber (not illustrated) of the internal combustion engine. It is possible to clearly see the chamber 19 formed, when the sliding piston 3 has been pushed downward by the opening stroke 23, at the top side of the cylindrical section 4 in the direction of the spring insert with the spring 22. This chamber 19 is equipped with the ventilation bore 20 such that, as the closing process is taking place, the cylindrical piston section 4 protrudes with its upper annular surface into said chamber 19, and forces the air which is situated there to the outside via the ventilation bore 20. The diameter of said ventilation bore is now selected such that no significant throttling effects arise, in order that, as the cylindrical section 4 protrudes into the chamber 19, no pressure cushion which generates a high resistance is formed, with rather only a certain damping cushion forming in order that an abutment of the upper annular surface of the cylindrical piston section 4 against the spring insert can be avoided even in the case of high opening and closing speeds of the high-pressure inlet valve 1 according to the invention.

FIG. 3 shows a sectional view through the section plane A-A showing guide webs 15, which run radially from the shank 14, between the shank 14 and the housing 2. These guide webs 15 ensure additional stability for exact axial guidance and additionally radial guidance of the sliding piston 3 in the housing 2, which is of importance for reliable sealing of the cylindrical outer surface of the cylindrical piston section 4 against the accurately fitting guide sections, which are likewise of correspondingly cylindrical form, in the housing 2. By means of this exact form of these two surfaces which slide relative to one another, the sealing action of the valve in the interior is ensured.

Finally, FIG. 4 shows, as a detail sectional view, that part of the high-pressure inlet valve 1 at which, in the combustion pressure outlet 18, the closing disk of the disk valve 12 is shown, which is situated as part of the sliding piston 3 in the closed position 7 thereof. For the targeted influencing of the flow direction, guide-vane-like webs 16 (see also FIG. 5) are provided at the transition of the closing disk of the disk valve 12 to the shank 14 thereof. The function of the guide-vane-like webs 16 consists in directing the combustion air at the inlet into the combustion chamber, when the sliding piston 3 is in its passage position 8, such that an optimum flow and optimum distribution of the combustion air and ultimately also optimum mixture formation prior to the combustion in the combustion chamber can be effected. As is known, a flow of the combustion air in the cylinder or in the combustion chamber which is correspondingly adapted to the shape of the combustion chamber leads to a more uniform and better mixture formation, whereby the combustion can be improved and thus the efficiency of the internal combustion engine can be increased.

FIG. 5 illustrates a detail view analogous to that in FIG. 4, in which, instead of webs 16 formed in an axial direction, guide-vane-like webs 16 are formed in a curved path at the transition of the closing disk of the disk valve 12 to the shank 14 thereof, preferably in doubly curved form. Such curved guide-vane-like webs 16 contribute to swirling of the combustion air that is introduced into the combustion chamber, which contributes to a homogenization of the mixture formation in the cylinder as a prerequisite for good combustion. The position of the disk valve 12 of the sliding piston 3 corresponds to the closed position 7.

FIG. 6 shows a further exemplary embodiment of the high-pressure inlet valve 1 according to the invention, in which the sliding piston 3 has two piston sections 4 of cylindrical form which are guided in corresponding guide sections 5. For this purpose, three cylindrical guide sections 5, which are formed so as to be of congruent shape, are provided in the interior of the housing 2. FIG. 6 shows the closed position 7 of the sliding piston 3 within the housing 2. The basic construction discussed with regard to FIGS. 1 and 2, with the spring insert, is identical, and will therefore not be discussed in any more detail again here.

In the closed position 7 illustrated in FIG. 6, the cylindrical piston section 4, which is of relatively great axial length and which is shown in the lower part of the illustrated high-pressure inlet valve 1, is provided for the opening and closing of the air inlet channels 17 themselves. For this purpose, in the housing, in the closed position 7 shown in FIG. 6, the supply lines to air inlet channels arranged in the manner of a ring over the circumference of the end side, facing to the combustion chamber, of the high-pressure inlet valve 1 are covered by the cylindrical piston sections 4, such that a passage of the combustion air proceeding from the combustion air inlet 9 is shut off.

Formed below the piston top side is a chamber 19, into which the lower cylindrical piston section 4 protrudes in order to open up the air inlet channels 17. In order that no counter-pressure is generated in the air present in the chamber 19, a ventilation bore is provided in the interior along the longitudinal axis of the sliding piston 3. With corresponding dimensioning of the ventilation bore, throttling can be substantially prevented, but it can nevertheless also be ensured that a certain damping function is established which prevents a hard abutment of the front side, which is the bottom side in the illustration as per FIG. 6, of the cylindrical piston section 4 in the interior of the housing against the base of the chamber. The annular surfaces 13 facing toward the passage region 6, that is to say the first and second pressure-application regions 10, 11 of the cylindrical piston sections 4 of the sliding piston 3, are dimensioned so as to be of equal size. It is thus achieved that, irrespective of the pressure at which the combustion air enters the passage region 6 in the interior of the housing 2 of the high-pressure inlet valve 1, no resulting axial forces are caused. In this way, irrespective of the pressure of the combustion air that is to be admitted into the combustion chamber, the high-pressure inlet valve can be opened counter to the action of the spring 22 merely by means of a corresponding drive, for example of a cam or of a camshaft, and applied or used through utilization of the action of the spring 22 the high-pressure inlet valve can be closed.

It is shown in FIG. 7 how, by this opening force F_{N}, imparted by a cam, the displacement piston 3 plunges into the chamber 19, such that the radially directed supply regions, leading to the air inlet channels 17 and in the manner of an annular chamber, are opened, and the combustion air can be introduced from the combustion air outlet 18 into the cylinder or combustion chamber of the internal combustion engine. As a result of the opening of the high-pressure inlet valve 1, the chamber 19 forms at the upper cylindrical piston section 4 for the guidance of the sliding piston 3 in the housing 2 at the corresponding guide section 5. This chamber 19 is also connected to a ventilation bore 20, such that, as the sliding piston 3 performs the closing movement, that is to say during an upward movement in the drawing, the air situated in the chamber 19 can escape via the ventilation bore 20. Preferably, the air inlet channels 17 are arranged equidistantly; it is however also possible for an irregular arrangement to be provided, in particular if, in this way, the air flow into the combustion chamber is to be used for improving the mixture formation.

FIG. 8 shows a detail view of that region of the air inlet channels, that is to say of the lower region of the high-pressure inlet valve 1, in which, in a departure from the embodiment as per FIG. 6 and FIG. 7, the air inlet channels 17 are arranged so as to diverge with respect to the longitudinal axis of the sliding piston 3. The other geometrical conditions correspond to those of FIGS. 6 and 7.

FIG. 9 illustrates an exemplary embodiment in the form of a detail region as per FIG. 8, wherein, however, the air inlet channels 17 are arranged so as to converge with respect to the longitudinal axis of the sliding piston 3. It is however also possible that both air inlet channels 17 which diverge, and air inlet channels 17 which converge, with respect to the longitudinal axis of the sliding piston 3 are provided in a single embodiment.

FIG. 10 shows a further exemplary embodiment of a high-pressure inlet valve 1 according to the invention, the basic construction of which with regard to housing 2 and spring insert corresponds to the preceding exemplary embodiments, such that these parts will not be described in any more detail again here. The illustrated high-pressure inlet valve 1 is situated in its closed position 7 of the sliding piston 3. The difference in relation to the preceding exemplary embodiments consists in that the combustion air inlet 9 and the combustion air outlet 18 are arranged in different planes with respect to the longitudinal axis of the housing 2 of the high-pressure inlet valve 1. Here, the combustion air is applied at high pressure via the combustion air inlet 9 proceeding from a high-pressure line which is not illustrated. In the closed position 7, the lower cylindrical piston section 4 covers said passage region 6, such that no combustion air can pass into the passage region 6 and ultimately into the combustion chamber 25 (see FIGS. 15 and 16) of the cylinder.

Facing toward the passage region 6 are two annular surfaces 13 which are of the same size, such that there are no resultant axial forces irrespective of the pressure of the supplied combustion air. A displacement of the sliding piston 3 therefore only has to be imparted counter to the force of the spring 22. Situated below the front side of the large cylindrical piston section 4 is, in turn, the chamber 19, such that, during the displacement of the sliding piston 3, a protruding movement into the chamber 19 occurs and thus, ultimately, as the opening stroke 23 is performed, the passage position 8 of the sliding piston 3 as shown in FIG. 11 is reached. In the passage position 8, the combustion air can flow via the combustion air inlet 9 from the lower plane to the upper plane of the recess of the passage region 6 in the housing 2 and ultimately to the combustion air outlet 18, from where the combustion air can flow directly into the combustion chamber 25 of an internal combustion engine (not shown).

In order that reliable guidance of the sliding piston 3 in the housing 2 is ensured, the lower, relatively large cylindrical piston section 4 is guided as far as into the chamber 19 on guide sections 5 of congruent shape. In the closed position 7 as per FIG. 10, this cylindrical piston section 4 is then guided in the lower region and in the intermediate region on corresponding guide sections 5, wherein the intermediate region is arranged between the lower plane at the combustion air inlet 9 and the passage region 6 in the upper plane at the combustion air outlet 18. Finally, the relatively small cylindrical piston section 4, which is the upper cylindrical piston section arranged in the direction of the spring insert, is guided in sliding fashion on a third guide section 5.

FIGS. 12a) and b) illustrate, in a detail sectional view of the region of the combustion air inlet 9 of the high-pressure inlet valve 1, that the flow channel from the combustion air inlet 9 to the passage region 6 need not imperatively be formed as a cylindrical bore, but may be formed in the manner of an elongate hole in cross section as illustrated in FIG. 12b). Other cross-sectional shapes are self-evidently possible. FIG. 12a) shows, in plan view, the annular surface 13, the size of which is identical to the annular surface, pointing toward said annular surface 13, of the second cylindrical piston section 4 (see FIGS. 10 and 11). These oval or adapted cross sections of the air supply allow an enlarged supply cross section without the need for the valve to be of longer form.

FIGS. 13a) and b) show a detail sectional view of the region of the combustion air outlet 18, wherein, again, the shank 14 and the annular surface 13 on the cylindrical piston section 4 are illustrated. For this exemplary embodiment, too, different cross-sectional shapes of the combustion air channel are conceivable. FIG. 13b) illustrates, in the region between the annular surfaces 13, which face toward one another and which are of equal size with regard to the pressure action, of the cylindrical piston sections 4, an annular recess which enlarges the passage region 6. Said annular recess is connected at one side to the combustion air inlet 9 and at the other side to the combustion air outlet 18 (neither of which is shown). These oval or adapted cross sections of the air supply allow an enlarged supply cross section without the need for the valve to be of longer form.

FIG. 14a) shows a sliding piston 3 which has a front cylindrical piston section 4 of relatively large axial length and a rear cylindrical piston section 4 of relatively small axial length. The two annular surfaces 13, which face toward one another and which have a section of the shank 14 between them, are of equal size, such that, when said intermediate region, that is to say the region of the annular surfaces, which point toward one another, of the two cylindrical piston sections 4, is charged with combustion air, even at high pressure, no resulting axial force component is generated. The pistons of the sliding piston 3, that is to say the cylindrical piston sections 4, have piston annular grooves 21 on their circumference in encircling form, which piston annular grooves are suitable for receiving lubricating oil such that sliding in a correspondingly formed housing 2 with the corresponding guide sections 5 is improved, because characteristics of lubricated sliding can be realized.

FIG. 14b) shows an exemplary embodiment, which is substantially analogous to that in FIG. 14a), of a sliding piston, in the case of which piston annular grooves 21 are formed into the outer surfaces of the cylindrical piston sections 4 in helically encircling fashion. These piston annular grooves 21 are also formed such that lubricant can be received therein and the cylindrical piston sections 4 together with the guide sections are guided in an effective manner and form well-lubricated sliding surfaces.

FIG. 15 shows an exemplary embodiment regarding how a high-pressure inlet valve 1 according to the invention can be arranged in the cylinder head 26 of an internal combustion engine. The high-pressure inlet valve 1 is driven by means of a cam 28, which preferably belongs to a camshaft, such that, upon engagement of the cam 28, the spring 22 present in the spring insert can be compressed, whereby the combustion air which is conducted via the high-pressure line 27 to the combustion air inlet 9, and which passes from there via the illustrated passage position through the high-pressure inlet valve 1, in the passage region 6 thereof, to the combustion air outlet 18, passes at high pressure into the combustion chamber 25. This is indicated by the chain of arrows which denotes the air flow of the highly pressurized combustion air. Shown on the left at the top side of the image is an outlet valve 29 which is situated in the open state, such that combustion gas can escape into the exhaust-gas line. In the cylinder 25, a piston 30 is shown which is connected by means of a piston pin 32 and a connecting rod 31 to a crankshaft. The high-pressure inlet valve 1 can then preferably be controlled such that, basically at virtually any position of the movement of the piston 30 from bottom dead center to top dead center, within every desired position, individual quantities of combustion air, or else the oxygen quantity required for the combustion in the combustion chamber 25, can be introduced by means of the combustion air in an opening process of the cylinder.

Finally, FIG. 16 shows a cylinder 25 with cylinder head 26 as per FIG. 15, but in a slightly differently situated section plane, wherein it is shown that the high-pressure inlet valve 1 is situated in its closed position 7. Owing to the differently situated section plane, the injection nozzle 33 is also shown. The piston 30 in the cylinder 25 is connected by means of its connecting rod 31 and via the piston pin 32 to a crankshaft (not shown).

FIG. 17a) shows a further exemplary embodiment of the high-pressure inlet valve 1 according to the invention. FIG. 17b) shows said high-pressure inlet valve 1 in an open position.

The closed position of the high-pressure inlet valve 1 as shown in FIG. 17a) is achieved in the position of the sliding piston 3 with respect to the guide sections 5 in the interior of the housing 2 and when the combustion air inlet 9 is closed, wherein, during the opening thereof, combustion air is supplied at high pressure, specifically when a valve disk of a disk valve 12 is sealingly seated in a valve seat and thus likewise arranged so as to seal off the supply of combustion air into the combustion chamber 25. It is commonly the case, for valves that are used in the cylinder head 26 of internal combustion engines, that the valve disk of the disk valve 12 transitions in continuous fashion into the shank 14. The sliding piston 3 has, in the region of the shank 14 situated in the housing 2, a cylindrical piston section 4 which forms an annular surface 13 which points in the direction of the passage region 6. On a side situated opposite the annular surface 13, the shank 14 has a valve disk of the disk valve 12, which preferably, with an angle of 45°, forms a sealing seat with the housing 2. The sealing force of said valve seat is ensured by means of a spring 22, which is held under preload by means of a yoke-like support ring 36 in the housing 2. The annular surface 13 and the effective area, projected onto a plane perpendicular to the longitudinal axis of the sliding piston 3, of the valve disk of the disk valve 12 are of equal size, such that the pressure of the combustion air that passes into the passage region 6 for introduction into the cylinder 25 when the high-pressure inlet valve 1 is open (see FIG. 17b)) subjects the pressure-application surfaces 10 and 11 to load toward one another without resulting forces. In this way, virtually force-free displacement of the sliding piston 3 in the housing 2 is realized. In the region of the shank 14, the sliding piston 3 has an additional piston 34, which likewise has a cylindrical piston section 4 on its outer circumference, which cylindrical piston section is guided on corresponding guide sections 5, which are of congruent shape, in the housing 2. The axial dimension of said additional piston 34 is such that, in the position which is shown in FIG. 17a), that is to say in which the supply of combustion air is shut off, the additional piston 34 blocks the cross section of the feed line of the combustion air at high pressure. For this purpose, the additional piston 34, like the guide sections 5, is ground in order to ensure a corresponding sealing force. A second sealing surface is formed in the valve seat of the disk valve 12, wherein the sealing force is determined by the spring force of the spring 22. Above the top side, shown in FIG. 17a) and pointing toward the side with the high-pressure spring of a valve, of the piston section 4, there is formed a pressure chamber which, in the event of corresponding compression, that is to say upward movement, of the sliding piston 3, can be ventilated via a ventilation bore 20.

In the presence of a corresponding force, acting counter to the spring force of the spring 22, for the adjustment of the sliding piston 3 in the housing 2, air is drawn in again via said ventilation bore 20, such that no significant negative pressure is generated in the pressure chamber that is present between the top side of the cylindrical piston section 4 and the housing 2.

FIG. 17b shows the high-pressure inlet valve 1 as per FIG. 17a, but in the open position. For this purpose, the sliding piston 3 has been displaced downward in the illustration shown, counter to the action of the spring force of the spring 22, such that the additional piston 34 opens up the access cross section 9 via the passage region 6 at the seat region of the valve disk of the disk valve 12 and combustion air can be forced at high pressure into the combustion chamber 25 (not shown). The other elements and functions are identical to those as per FIG. 17a, and will therefore not be described once again here. It can be seen in FIG. 17b that the additional piston 34 is displaced in sliding fashion on the ground cylindrical guide surfaces 5 formed in the interior of the housing 2, that is to say in the interior of the passage region 6, such that the highly pressurized combustion air can ultimately flow into the cylinder 25.

Finally, FIG. 17c shows a sectional view through the sliding piston 3 in its lower part of the shank 14, in a view directed toward the additional piston 34 from below. The piston 34 has a cylindrical piston section 4 at its outer circumference, which cylindrical piston section is ground and interacts sealingly, in a congruently shaped manner, with the guide sections 5 correspondingly formed in the housing 2. The interior of the piston 34 is manufactured so as to have sufficient stability by means of spokes, between which openings are situated, and thus makes it possible, when the combustion air inlet is opened up, for the combustion air to flow through in order to subsequently flow past the region of the valve seat of the valve disk of the disk valve 12 and into the combustion chamber 25. This is shown by arrows that indicate the flow path. Additionally, the sliding piston 3 is guided reliably and accurately by means of the cylindrical piston sections 4 in the upper part of the housing 2, because these regions are also ground.

Finally, FIG. 18 shows a further exemplary embodiment of the invention, in which the effective pressure-application regions 10, 11 facing toward the passage region 6 in the interior of the housing 2 are of different sizes. FIG. 18 shows a state of the high-pressure inlet valve 1 in which, owing to the sliding piston 3, combustion air is not being supplied into the combustion chamber 25. Owing to the fact that the second pressure-application region 11, formed as an annular surface 13, is larger than the first pressure-application region 10 at the transition of the valve disk of the disk valve 12 to the shank 14 thereof, the housing 2 is of two-part form in order that the sliding piston 3 can be correspondingly installed into the interior of the housing 2. The basic construction is otherwise analogous to that described in FIG. 17. By virtue of the fact that the area of the pressure-application region 11 is larger than that of the pressure-application region 10, in conjunction with the high pressure of the combustion air, a greater closing force of the valve disk of the disk valve 12 in the region of its seat is ensured. In this respect, the inequality based on the effective areas of different size is benefited from. The high force thus achieved ensures a considerably improved sealing action of the valve seat during the operation of the engine. The principle of the function of a valve of said type is that which is similar to a pneumatic cylinder. In addition to the illustration in FIG. 17, FIG. 18 also shows a locknut 37 which prevents a detachment of the support ring 36 during operation, wherein an adjustment of the spring force can however also be performed by means of said locknut 37, because the support ring 36 is screwed onto the upper shank part of the sliding piston 3, such that the spring stress can be adjusted, and fixed in accordance with the desired level, by means of the locknut 37.

FIG. 19 and FIG. 20 show, in a sectional illustration, two positions of the high-pressure inlet valve 1, provided for implementing the method according to the invention, in a further embodiment of the invention in a closed state (FIG. 19), whereas said high-pressure inlet valve 1 is illustrated in an open position in FIG. 20.

The high-pressure inlet valve 1 has a piston part which is formed from a piston plunger 100 and a piston 200 and which is guided in a housing 300. The piston 200 has an encircling piston groove 50 which forms a control edge 40 and which has a region with a narrowing in relation to the outer maximum diameter of the piston 200. In the position as per FIG. 19, the piston 200 within the housing 300 forms, at its end surface or piston top side, which is situated opposite the piston plunger 100, a valve chamber 90 which is closed at the end side of the high-pressure inlet valve 1 by means of a cover plate 60. Between the cover plate 60 and the end side of the piston 200, the valve chamber 90 forms, as it were, an air cushion into which the piston 200 moves during its stroke 101 such that, in the case of the the short times that are required for the processes of admitting combustion air into the cylinder, the piston 200 is prevented from being able to strike the cover plate 60. It is shown in FIG. 20 that the valve chamber 90 is ventilated via a ventilation bore 70 that is led through the piston part in the region of its longitudinal axis. In particular in the case of relatively high rotational speeds of the internal combustion engine, the charge exchange in the cylinder must be performed in very short periods of time in relation to absolute timescales. It is therefore also necessary for the high-pressure inlet valve 1 and, as main core element thereof, its piston 200, to perform very fast movements for opening and closing, that is to say for controlling the supply of combustion air.

At the dead centers during the movement of the sliding piston 3 of the high-pressure inlet valve 1, relatively high acceleration and deceleration forces arise owing to the inertia of said component. The space which varies on the piston top side during the movement of the sliding piston 3, that is to say the valve chamber 90, leads to damping of the piston movement owing to the compression of the air situated therein, for which reason a ventilation bore 70 is provided in the interior of the sliding piston 3 in the region of the longitudinal axis thereof. The diameter of the ventilation bore 70 is then configured such that, during the rapid movement of the piston itself of the sliding piston 3, the air is at least for the most part forced out of the valve chamber 90 via the ventilation bore 70. The diameter of the ventilation bore 70 is then so large that only such a quantity of air remains in the valve chamber 90 that, during the rapid movement of the piston 200 and its inertia, an abutment of the piston top side thereof against the inner termination, formed in this exemplary embodiment by the cover plate 60, of the high-pressure inlet valve 1 does not abut. On the other hand, the ventilation bore 70 must be capable, during the return movement of the piston away from the cover plate 60 in the direction of its position for shutting off the passage of combustion air through the high-pressure inlet valve 1, of allowing a backflow for the refilling of the valve chamber 90. The ventilation bore 70 therefore has a diameter such that, substantially, the air in the valve chamber 90 can be discharged and fed back into said chamber, specifically nevertheless with the presence of a certain throttling function, in order that no vacuum or negative pressure arises in said valve chamber 90 during the reciprocating movement of the piston 200 in the housing 300 of the high-pressure inlet valve 1. That proportion of the air which remains in the valve chamber 90 serves, at any rate during the movement of the piston top side in the direction of the cover plate 60, for realizing a certain damping effect in that, inter alia also owing to the still remaining throttling action of the ventilation bore 70, a certain damping air cushion forms, whereby an abutment of the piston top side against the inner side of the cover plate 60 is prevented, or an abutment is counteracted.

On that side of the piston 200 which is situated opposite the end side of the piston and at which the piston plunger 100 is arranged, a lower or rear valve chamber is arranged within the housing 300 between the piston lower side and the passage opening of the piston plunger 100 through the material of the housing 300, which lower or rear valve chamber likewise has a damping function analogous to that discussed at the piston top side. For this purpose, a ventilation bore 70 is likewise provided out of said damping chamber at the piston bottom side, which ventilation bore is configured and functions analogously to the ventilation bore 70 and leads in a longitudinal direction through the piston part and has a connection to the valve chamber 90.

In the upper region of the housing 300 of the high-pressure inlet valve 1, the piston plunger 100 is surrounded by springs, which are arranged in a housing recess 130 and which are held by means of a guide plate flange-mounting the housing recess 130 in an upward direction. The piston thus works counter to the spring 80, which is compressed or stretched in a manner dependent on the movement direction within the piston stroke 101.

In the position of the piston 200 illustrated in FIG. 19, the control edge 40 of said piston is situated above a channel, arranged transversely with respect to the movement direction of the piston 200, for the compressed-air supply 121 to the cylinder, such that the passage of the compressed-air supply 111 through the valve is prevented. Only in the position of the piston 200 illustrated in FIG. 20 has the control edge 40 protruded into the channel, which extends transversely with respect to the longitudinal axis of the piston and which extends through the housing 300 of the high-pressure inlet valve, for the compressed-air supply 121 to the cylinder. When the control edge 40 has opened up said channel of the compressed-air supply 121 to the cylinder, the compressed-air supply 111 can flow via the piston groove 50, which encircles the piston 200 and, as it were, constitutes the narrowing in relation to the maximum diameter of the piston, in the direction of and through the channel for the compressed-air supply 121 to the cylinder. Owing to the high pressure at which the compressed-air supply 111 to the valve prevails at the corresponding channel of the high-pressure inlet valve 1, an immediate passage of the highly pressurized combustion air into the cylinder occurs after the opening-up and thus connection to the channel of the compressed-air supply 121 to the cylinder.

Since, during the movement of the piston 200 in the housing 300, the piston 200 acts only against the respective air cushion, that is to say with its piston top side into the air cushion of the valve chamber 90 or with the piston bottom side into the air cushion, taking into consideration the respectively acting spring force, and since, on the other hand, the piston groove 50 has an equal area at both ends in a longitudinal direction, there are no significant additional resulting axial forces that act on the piston 200. The piston 200 can therefore, despite high acting pressures of the combustion air, be adapted easily and thus to the rotational speed of the internal combustion engine that corresponds to the high required speeds.

The high-pressure inlet valve 1 provided for carrying out the method according to the invention thus offers the possibility of providing highly pressurized combustion air to a consumer, in this case to the cylinder of an internal combustion engine. The pressures of the provided compressed air or combustion air lie for example at 120 bar. By virtue of the fact that the axial forces acting on the piston 200 are substantially balanced owing to equal areas subjected to load, there is no resulting unilateral force component on the piston 200 or the piston plunger 100 to the detriment of the respective other movement direction. It is thus possible for the piston to be moved into the respective switching states with less exertion of force. The respective switching states are, on the one hand, the closed valve and, on the other hand, the opened valve.

Here, the size of the opening in the opened switching state can be varied by means of the magnitude of the axial displacement of the sliding piston 3. During the displacement of the piston, on the pressure side, the control edge 40 of the piston 200 is displaced to such an extent that, in the case of a corresponding width of the piston groove 50 as viewed in a longitudinal direction of the piston 200, the feed and discharge channels (compressed-air supply 111 and compressed-air supply 121) arranged offset with respect to one another in an axial direction are connected to one another via the piston groove 50, which corresponds to the opened state of the high-pressure inlet valve 1. By means of a variation of the position of the piston 200, the cross section of the compressed-air supply 121 to the cylinder can be varied such that the throughflow quantity, that is to say the mass flow, of the combustion air to be introduced into the cylinder can be varied.

The cross sections are then selected such that, in the opened state, large quantities of combustion air can be supplied in a short period of time, that is to say high mass flows can be supplied, to a consumer, in this case to the cylinder of an internal combustion engine. If it is the intention to move from an opened state (see FIG. 20) back into a closed state (see FIG. 19), the piston 200 is correspondingly displaced in an axial direction such that a connection of the compressed-air supply 111 to the high-pressure inlet valve 1 from a compressed-air source via the piston groove 50 to the compressed-air supply 121 to the cylinder is shut off. Before the actual shutting-off has occurred in accordance with the position, corresponding to this, of the piston 200 in the housing 300, it may be provided, for a further improvement in the operating behavior of the engine, that the closing process is delayed once again to a specified extent such that a certain follow-up charging effect can be realized in the cylinder. This follow-up charging occurs in the cylinder generally at a time when the piston 200 in the cylinder of the internal combustion engine is already performing its upward movement, that is to say in the compression phase. The advantage of the use of compressed combustion air in conjunction with the high-pressure inlet valve 1, as already described above, consists inter alia in that, after opening-up of the corresponding cross sections, the compressed air propagates rapidly because the compressed air expands rapidly in a free cross section. This also assists the capability of the method according to the invention with the high-pressure inlet valve 1 whereby large quantities of air can be passed through in a short period of time. The supply of combustion air to a respective cylinder can then be performed such that the entirety of the combustion air for one cycle is conducted by way of one introduction into the cylinder in one admission process. In the context of an optimization of, for example, the compression work to be performed by the piston 200, the high-pressure inlet valve 1 can be controlled such that the supply of the combustion air into the cylinder occurs, as it were, in multiple bursts. Each individual burst of supplied combustion air can in this case be varied with regard to the length of the opening of the high-pressure inlet valve 1, such that the engine operation can be directly influenced, specifically by way of the quantity of combustion air introduced into the cylinder in a defined period of time. It is preferable for two such bursts to be provided. A multiplicity of bursts of supplied fresh air may however indeed also be advantageous here in the context of optimizing the overall process of the operation of the engine. If the combustion air is introduced in partial quantities in multiple bursts during the movement of the piston 200 in the cylinder on its path from bottom dead center to top dead center during the compression stroke, then the combustion air quantity corresponds, in sum total, to the total quantity which is required for the respective cycle and with which reliable operation of the engine, which ensures high efficiency of the internal combustion engine, can be achieved.

The sealing of the piston 200 within the housing 300 is realized by means of a corresponding fit between the piston 200 and the bore in the housing 300.

The high-pressure inlet valve 1 is preferably constructed from high-strength and heat-resistant aluminium alloys or from steel/cast metal or from ceramic materials, wherein it is also possible for different materials to be used for the piston 200 and the housing 300. A selection of a particular base material with a coating of the respective parts is also conceivable in order to achieve optimum sliding and sealing characteristics of the piston 200, which moves in the housing 300, at the high pressures of the supplied combustion air. Aside from a selected coating, a different heat treatment of the parts which move relative to one another in the high-pressure inlet valve 1 is also conceivable. In order to reduce friction, it is also possible for lubrication to be provided between the piston 200 and the housing 300, wherein a supply line (not illustrated in the figures) may be provided for the supply of small quantities of lubricant.

For the execution of the method, it is expedient for the high-pressure inlet valve 1 to be connected in place of conventional inlet lines and inlet valves in the cylinder head 26 of an internal combustion engine, whereas the exhaust-gas valves and the exhaust-gas lines may continue to be formed using conventional technology. The high-pressure inlet valve 1 may self-evidently also be used for other forms of supply of gases into chambers of other devices.

In order to realize correspondingly rapid opening and closing processes of the high-pressure inlet valve 1, in order that the method can be carried out effectively, it is also possible that the piston of the high-pressure inlet valve 1 is actuated by means of mechanical components such as a camshaft.

Despite the relatively small opening cross sections on the side of the compressed-air supply 111 to the valve, large air quantities can be introduced into the combustion chamber owing to the high supply at pressures of up to 150 bar. This is also possible because the compression of the combustion air on the side of the compressed-air supply 111 to the valve already expands on the valve. The expansion of the combustion air already in the valve assists, as it were, the “flow speed” of the combustion air in the direction of the compressed-air supply 121 to the cylinder and into the cylinder, whereby a greater quantity of combustion air in the same period of time, that is to say a greater mass flow, is thus automatically conveyed into the combustion chamber, the cylinder 25.

Since the sliding piston 3 performs a controlled linear movement, the opening cross sections can be controlled in a simple manner by means of the periods of time for the opened state of the high-pressure inlet valve 1.

### LIST OF REFERENCE DESIGNATIONS

1 High-pressure inlet valve
2 Housing
3 Sliding piston
4 Cylindrical piston section
5 Guide section
6 Passage region
7 Closed position
8 Passage position
9 Combustion air inlet
10 First pressure-application region
11 Second pressure-application region
12 Disk valve/closing disk
13 Annular surface
14 Shank
15 Guide web
16 Guide-vane-like web
17 Air inlet channels
18 Combustion air outlet
19 Chamber
20 Ventilation bore
21 Piston annular grooves
22 Spring
23 Opening stroke, high-pressure inlet valve
24 Web, additional piston
25 Combustion chamber/cylinder
26 Cylinder head
27 High-pressure line
28 Cam/camshaft
29 Outlet valve
30 Piston
31 Connecting rod
32 Piston pin
33 Injection nozzle
34 Additional piston
35 Throughflow cross section
36 Support ring
37 Locknut
40 Control edge
50 Piston groove
60 Cover plate
70 Ventilation bore
80 Spring
90 Valve chamber
100 Piston plunger
101 Piston stroke
111 Compressed-air supply to the valve
121 Compressed-air supply to the cylinder
131 Housing recess
200 Piston
300 Housing

1. A method for introducing combustion air into a cylinder of an internal combustion engine, in which method the entirety of the combustion air for the respective cylinder is, in a manner controlled at least with regard to its mass flow by means of a high-pressure inlet valve arranged in the cylinder head or in the region thereof, introduced into the cylinder of the internal combustion engine at high pressure such that the combustion air intensifies mixture formation and charge exchange in the cylinder, characterized
in that the mass flow and the temperature and/or the pressure of the combustion air are measured and in that the quantity of combustion air is introduced into the cylinder, in a manner controlled by means of the high-pressure inlet valve, on the basis of the measurement results, and
in that the high-pressure inlet valve, which is formed with a sliding piston, is opened or closed by displacement of the sliding piston.

2. The method as claimed in claim 1, in which, during a compression stroke of a respective piston, the combustion air is admitted into the respective cylinder in the region of or proceeding from the first third of said compression stroke.

3. The method as claimed in claim 1, in which, during a compression stroke of a respective piston, the combustion air is admitted into the respective cylinder in the top dead center region of said compression stroke.

4. The method as claimed in claim 1, in which the combustion air is admitted into the respective cylinder during at least two time ranges of the compression stroke.

5. The method as claimed in claim 1, in which the combustion air is introduced into the cylinder at a pressure in the range of 50 to 150 bar.

6. The method as claimed in claim 1, in which the high-pressure inlet valve delays its closing and thus effects follow-up charging of the cylinder with combustion air.

7. The method as claimed in claim 1, in which fuel is fed to the combustion air before the latter is fed into the cylinder.

8. The method as claimed in claim 7, in which the fuel is combustion gas and/or liquid fuel.

9. The method as claimed in claim 1, in which the combustion air is fed from a pressure vessel to the cylinder.

10. The method as claimed in claim 1, in which the combustion air is fed to a two-stroke or a four-stroke internal combustion engine.

11. A high-pressure inlet valve (1) for introducing highly pre-compressed combustion air into a combustion chamber (25) of an internal combustion engine, which high-pressure inlet valve has a sliding piston (3) which is guided in a housing (2) and which has cylindrical piston sections (4), the axial lengths of which are adapted to axially extending guide sections (5), which are of congruent shape with respect to said cylindrical piston sections, in the housing (2) such that, during axial displacement of the sliding piston (3), passage regions (6), arranged between the guide sections (5) in the housing (2), for combustion air are shut off, and allow no combustion air into the combustion chamber (25), in a closed position (7) and, in the event of axial displacement into a passage position (8), allow combustion air through a combustion air inlet (9) through the passage region (6) into the combustion chamber (25), wherein the sliding piston (3), in the passage region (6), has two regions which face toward one another and which are formed as first (10) and second pressure-application regions (11), whose areas projected onto a plane are of equal size.

12. A high-pressure inlet valve (1) for introducing highly pre-compressed combustion air into a combustion chamber (25) of an internal combustion engine, which high-pressure inlet valve has a sliding piston (3) which is guided in a housing (2) and which has cylindrical piston sections (4), the axial lengths of which are adapted to axially extending guide sections (5), which are of congruent shape with respect to said cylindrical piston sections, in the housing (2) such that, during axial displacement of the sliding piston (3), passage regions (6), arranged between the guide sections (5), for combustion air are shut off, and allow no combustion air into the combustion chamber (25), in a closed position (7) and, in the event of axial displacement into a passage position (8), allow combustion air through a combustion air inlet (9) through the passage regions (6) into the combustion chamber (25), wherein the sliding piston (3), in its passage region (6), has two regions which face toward one another and which are formed as first (10) and second pressure-application regions (11), whose areas projected onto a plane are of different size.

13. A high-pressure inlet valve (1) for introducing highly pre-compressed combustion air into a combustion chamber (25) of an internal combustion engine, which high-pressure inlet valve has a sliding piston (3) which is guided in a housing (2) and which has a cylindrical piston section (4), the axial length of which is adapted to an axially extending guide section (5), which is of congruent shape with respect to said cylindrical piston section, in the housing (2) such that, during axial displacement of the sliding piston (3), the piston section (4) guided in the guide section (5) shuts off a passage region (6), arranged in the housing (2), for combustion air with respect to the passage of combustion air into the combustion chamber (25) in a closed position (7) and, in a passage position (8), opens up said passage region with respect to the passage of combustion air into the combustion chamber (25), wherein the sliding piston (3), in the passage region (6), has two regions which face toward one another and which are formed as first (10) and second pressure-application regions (11), whose areas, projected onto a plane, perpendicular to the longitudinal axis of the sliding piston (3) are of equal size or differ from one another slightly, and the first pressure-application region (10) is formed in the manner of a disk valve (12) and the second pressure-application region (11) is formed in the manner of an annular surface (13).

14. The high-pressure inlet valve (1) as claimed in claim 11, in which the first pressure-application region (10) is formed, with its contour at the combustion air outlet (18) for the admission of the combustion air into the combustion chamber (25), in the manner of a disk valve (12), and the second pressure-application region (11), situated opposite said first pressure-application region, is formed as an annular surface (13).

15. The high-pressure inlet valve (1) as claimed in claim 11, in the alternative of equal-sized first and second pressure-application regions (10, 11) and in the alternative of the first pressure-application region (10) formed as a disk valve (12), in which the sliding piston (3) has a shank (14) on which, in the passage region (6), there is provided an additional piston (34) which is equipped with webs (24) and which, between the webs (24), has through flow cross sections (35) for the combustion air and which guides the cylindrical piston section (4) guided on the guide section (5), which piston section (4) has such an axial length that, in a manner dependent on the axial position of the sliding piston (3), the additional piston (34) opens the passage region (6) for the admission of combustion air into the combustion chamber (25) or sealingly closes said passage region so as to prevent a passage of combustion air, wherein the disk valve (12) of the sliding piston (3), in its closed position, provides additional sealing in the valve disk seat.

16. The high-pressure inlet valve (1) as claimed in claim 13, the sliding piston (3) of which has a planar annular surface (13) on the cylindrical piston section (4).

17. The high-pressure inlet valve (1) as claimed in claim 11, in which the first pressure-application region (10) has guide webs (15) extending radially between a shank (14) and the guide section (5).

18. The high-pressure inlet valve (1) as claimed in claim 17, in which the first pressure-application region (10) has guide-vane-like webs (16), which extend between shank (14) and closing disk (12) at least with a directional component in an axial direction of the sliding piston (3), in order to realize a defined direction of the combustion air as it is admitted into the combustion chamber (25).

19. The high-pressure inlet valve (1) as claimed in claim 11, in which the first (10) and the second pressure-application regions (11) are assigned to their respective axially extending cylindrical piston section (4), which is guided in the respective guide section (5) in the housing (2), and delimit the passage region (6), wherein, during the axial displacement of the sliding piston (3), the cylindrical piston section (4) extending from the first pressure-application region (10) opens or closes air inlet channels (17) arranged in the housing (2).

20. The high-pressure inlet valve (1) as claimed in claim 19, in which the air inlet channels (17) extend in the housing (2) in annular fashion with a defined spacing to one another in an axial direction, in a direction in which they converge on one another, or in a direction in which they diverge from one another, toward the combustion chamber (25).

21. The high-pressure inlet valve (1) as claimed in claim 11, in which the passage region, delimited by the first (10) and the second pressure-application region (11), for the combustion air in the housing (2) has a combustion air inlet (9) and a combustion air outlet (18), which regions are arranged offset with respect to one another in an axial direction of the sliding piston (3), wherein the combustion air inlet (9) is, depending on the position of the sliding piston (3), shut off or opened for the combustion air by means of a cylindrical piston section (4) which extends from the first pressure-application region (10) and which is guided in the housing (2) in the guide section (5).

22. The high-pressure inlet valve (1) as claimed in claim 21, in which, during the displacement of the sliding piston (3), the cylindrical piston sections (4) respectively assigned to the pressure-application regions (10, 11) protrude into respective chambers (19) in the housing (2), which chambers have ventilation bores (25) via which air which is pressurized as the cylindrical piston sections (4) protrude into the respective chamber (19) escapes.

23. The high-pressure inlet valve (1) as claimed in claim 21, in which the combustion air inlet (9) and/or the combustion air outlet (18) have/has a circular, elongate or elliptical cross section.

24. The high-pressure inlet valve (1) as claimed in claim 23, in which the cylindrical piston sections (4) are formed in the manner of lubricant-receiving piston annular grooves (21).

25. The high-pressure inlet valve (1) as claimed in claim 12, in which the areas, projected onto a plane, of the first (10) and of the second pressure-application region (11) differ from one another by at most 20%.

26. The high-pressure inlet valve (1) as claimed in claim 12 in the alternative of different-sized pressure-application regions (10, 11) and the alternative of the first pressure-application region (10) formed as a disk valve (12), in which, in the closed position (7), the passage region (6) is sealed off in the direction of the combustion chamber (25) by the disk valve (12) and in the direction of the spring-loaded side of the sliding piston (3) by the cylindrical piston region (4) on the shank (14), wherein the second pressure-application region (11) of the cylindrical piston section (4) is larger than the effective first pressure-application region (10) in the form of a valve disk of the disk valve (12) such that the valve disk imparts sealing with respect to the combustion chamber (25) owing to the combustion air pressure.

27. The high-pressure inlet valve (1) as claimed in claim 13, in which the sliding piston (3) is formed such that, at least at the end of its closing movement, it imparts a radial movement component to the disk valve (12).

28. An internal combustion engine having a high-pressure inlet valve (1), which is arranged in a cylinder head (26) and which serves for the admission of combustion air at high pressure into a combustion chamber (25), having the features as claimed in claim 1, which high-pressure inlet valve is arranged in the manner of an inlet valve between a high-pressure line (27) and the combustion chamber (25) and by means of which high-pressure inlet valve the combustion air can be admitted from a high-pressure line (27) via a passage region (6) of the high-pressure inlet valve (1) into the combustion chamber (25), wherein the high-pressure inlet valve (1) is arranged in the cylinder head (26) in standing fashion in relation to the longitudinal axis of the cylinder (25).

29. An internal combustion engine having a high-pressure inlet valve (1), which is arranged in a cylinder head (27) and which serves for the admission of combustion air at high pressure into a combustion chamber (25), having the features as claimed in claim 1, which high-pressure inlet valve is arranged in the manner of an inlet valve between a high-pressure line (27) and the combustion chamber (25) and by means of which high-pressure inlet valve the combustion air can be admitted from a high-pressure line (27) via a passage region (6) of the high-pressure inlet valve (1) into the combustion chamber (25), wherein the high-pressure inlet valve (1) is arranged in the cylinder head (26) in lying fashion in relation to the longitudinal axis of the cylinder (25).

30. The internal combustion engine as claimed in claim 28, in which the sliding piston (3) of the high-pressure inlet valve (1) is loaded by means of a spring (22), and a cam, which acts counter to the spring force, of a camshaft is provided for the displacement of the sliding piston (3) of said high-pressure inlet valve from a position in which it shuts off a passage of combustion air into the combustion chamber (25) into a position in which it allows the passage of combustion air into the combustion chamber (25).

31. The internal combustion engine as claimed in claim 28, in which the high-pressure inlet valve (1), which operates with a pressure in the range from 2 to 20 MPa, can be controlled, and the combustion air can be admitted into the cylinder (25), such that no separate stroke is required for a charge exchange in a four-stroke engine and such that mixture formation in the cylinder (25) can be controlled with regard to the injected fuel quantity by means of the pressure at which the combustion air is admitted into the combustion chamber (25) via the high-pressure inlet valve (1).
